(19) United States
(12) Patent Application Publication
(10) Pub. No.: US 2017/0162210 A1
(43) Pub. Date: Jun. 8, 2017

(54) METHOD AND DEVICE FOR AUDIO DATA PROCESSING

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Jianyong CUI, Tianjin (CN); Jijian ZHENG, Tianjin (CN); Hong CAO, Tianjin (CN)

(21) Appl. No.: 15/245,123

(22) Filed: Aug. 23, 2016

Related U.S. Application Data
(63) Continuation of application No. PCT/CN2016/088892, filed on Jul. 6, 2016.

(30) Foreign Application Priority Data
Dec. 3, 2015 (CN) 201510885337.X

(51) Int. Cl. G10L 19/22; G10L 19/16

(52) U.S. Cl. CPC G10L 19/22; G10L 19/167; H04L 65/4069

(57) ABSTRACT

Embodiments of the present disclosure disclose a method and a device for audio data processing. The method comprises detecting a received audio data packet to determine a stream type of the audio data packet, obtaining tag data of the audio data packet when the stream type is a first stream type, determining whether the tag data belongs to preset Dolby tag information, determining the first stream type as the stream type corresponding to a Dolby DVB standard when the tag data belongs to the preset Dolby tag information, and decoding the audio data packet by means of a Dolby decoder to generate audio data.

### CROSS-REFERENCE TO RELATED APPLICATIONS

This application is a continuation of International Application No. PCT/CN2016/088892 filed on Jul. 6, 2016, which is based upon and claims priority to Chinese Patent Application No. 201510855337.X, entitled “METHOD AND DEVICE FOR AUDIO DATA PROCESSING”, filed Dec. 3, 2015, and the entire contents of all of which are incorporated herein by reference.

### TECHNICAL FIELD

The disclosure relates to the technical field of multimedia data processing, and in particular, to a method for audio data processing and a device for audio data processing.

### BACKGROUND

With the rapid development of science and technology, the popularization of terminals is becoming faster and faster, and the functions of the terminals are becoming richer and richer. Among the functions, an audio playing function is an important function of the terminals. By means of the audio playing function, the terminals are able to play audio data, for example, playing music, and playing audio data while playing such videos as films, TV dramas, and animations.

The inventor finds out in the process of implementing the present disclosure that a system, for example, Android system, of one terminal already supports playing of Dolby sound sources, i.e., audio data generated by means of the Dolby technology. However, the Dolby sound sources have two standards, one of which is Digital Television Terrestrial Broadcasting Standard of China, namely Advanced Television Systems Committee (ATSC) standard, while the other is Digital Video Broadcasting (DVB) standard. The support of the Android system of one terminal to Dolby is only restricted to processing on the audio data of the Dolby ATSC standard, rather than processing on the audio data of the Dolby DVB standard. Actually, in existing analysis processes, the audio data of the Dolby DVB standard is often mistakenly recognized as that of Digital Theatre System (DTS) standard, thereby leading to a failure in parsing the audio data of the Dolby DVB standard; consequently, the audio data cannot be played.

### SUMMARY

The technical problem to be solved by embodiments of the present disclosure is to disclose a method for audio data processing, thereby avoiding misrecognition of the audio data of the DVB standard as that of the DTS standard, completing analysis of the audio data of the Dolby DVB standard and realizing playing of the audio data of the Dolby DVB standard.

Accordingly, the embodiments of the present disclosure also provide a device for audio data processing to ensure the implementation and application of the above method.

To solve the problem above, the embodiment of the present disclosure discloses a method for audio data processing, comprising:

detecting a received audio data packet to determine a stream type of the audio data packet;

obtaining tag data of the audio data packet when the stream type is a first stream type;

determining whether the tag data belongs to preset Dolby tag information;

determining the first stream type as a stream type corresponding to a Dolby digital video broadcasting standard when the tag data belongs to the preset Dolby tag information, and decoding the audio data packet by means of a Dolby decoder to generate audio data.

Correspondingly, the embodiment of the present disclosure further discloses an electronic device for audio data processing, comprising at least one processor; and a memory communicably connected with the at least one processor for storing instructions executable by the at least one processor, wherein execution of the instructions by the at least
one processor causes the at least one processor to:

detect a received audio data packet to determine a stream type of the audio data packet;

obtain tag data of the audio data packet when the stream type is a first stream type;

determine whether the tag data belongs to preset Dolby tag information;

determine the first stream type as a stream type corresponding to a Dolby digital video broadcasting standard when the tag data belongs to the preset Dolby tag information, and decode the audio data packet by means of a Dolby decoder to generate audio data.

The embodiment of the present disclosure further discloses a non-transitory computer-readable medium storing executable instructions that, when executed by an electronic device, cause the electronic device to, execute the method for audio data processing above.

Compared with the prior art, the embodiments of the present disclosure have the following advantages:

in the embodiments of the present disclosure, when a stream type of an audio data packet is a first stream type, tag data of the audio packet is obtained and a determination is made on whether the tag data belongs to Dolby tag information. When the tag data belongs to the Dolby tag information, the first stream type is determined as the one corresponding to the Dolby DVB standard, thereby avoiding misrecognition of the audio data packet of the DVB standard as that of the DTS standard. The audio data packet is then decoded by means of a Dolby decoder to generate the audio data. Therefore, the processing on the audio data packet of the Dolby DVB standard is completed, such that a terminal is able to play the audio data of the Dolby DVB standard.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow diagram of a method for audio data processing in accordance with some embodiments.

FIG. 2 is a step flow diagram of a method for audio data processing in accordance with some embodiments.

FIG. 3 is a structure block diagram of a device for audio data processing in accordance with some embodiments.

FIG. 4 is a structure block diagram of a device for audio data processing in accordance with some embodiments.

FIG. 5 schematically shows a block diagram of an electronic device for executing a method in accordance with some embodiments.

FIG. 6 schematically shows a storage unit for holding or carrying program codes for executing a method in accordance with some embodiments.

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure, not all embodiments. On the basis of the embodiments in the present disclosure, all the other embodiments obtained by a people skilled in the art without creative work should fall into the scope of protection of the present disclosure.

At present, the support of a system, for example, Android system, of one terminal to Dolby is only restricted to processing on audio data of Dolby ATSC standard, rather than processing on audio data of Dolby DVB standard.

In Dolby sound sources, a stream identifier corresponding to the audio data of the Dolby ATSC standard is different from a stream identifier corresponding to the audio data of the Dolby DVB standard. For example, a stream type of an audio data packet is labeled by hexadecimal data. The stream identifier corresponding to the audio data of the Dolby DVB standard is 0x06, which is labeled as Stream Type=0x06; the stream identifier corresponding to the audio data of the Dolby ATSC standard is 0x81 or 0x87, which is labeled as Stream Type=0x81 or Stream Type=0x87. In addition, a stream identifier corresponding to audio data of DTS-HD standard is also 0x06, which is also labeled as Stream Type=0x06, namely being the same as the stream identifier corresponding to the audio data of the Dolby DVB standard, wherein “HD” of the DTS-HD standard is short for High Definition. However, the audio data of the DTS standard may conflict with the audio data of the Dolby DVB standard. In existing analysis processes, the audio data of the Dolby DVB standard is often mistakenly recognized as that of Digital Theatre System (DTS) standard, thereby leading to a failure in parsing the audio data of the Dolby DVB standard; consequently, the audio data cannot be played.

Aiming at the above problem, one core concept of the embodiments of the present disclosure is as follows: the stream type corresponding to the same stream identifiers of the Dolby DVB standard and, the DTS-HD standard is labeled as a first stream type. When the stream type of an audio data packet is the first stream type, tag data of the audio data packet is obtained and a determination is made on whether the tag data belongs to Dolby tag information. When the tag data belongs to the Dolby tag information, the first stream type is determined as the one corresponding to the Dolby DVB standard, thereby avoiding misrecognition of the audio data packet of the DVB standard as that of the DTS standard. Therefore, the audio data packet of the Dolby DVB standard can be parsed, and the processing on the audio data of the DVB standard can be completed.

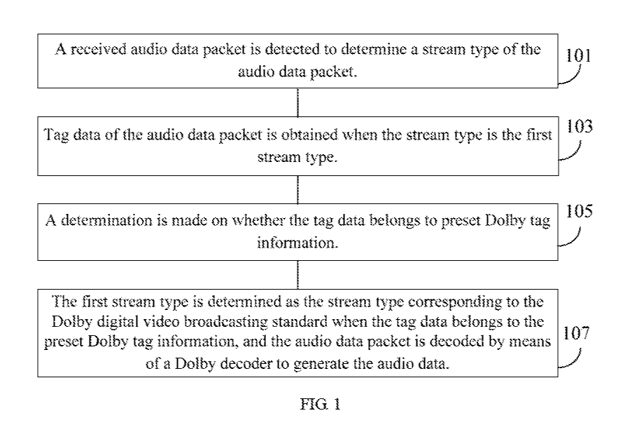

By referring, to FIG. 1, it shows the step flow diagram of the embodiment of the method for audio data processing of the present disclosure. The method may specifically include the following steps: Step 101, a received audio data packet is detected to determine a stream type of the audio data packet.

Typically, a transport stream (TS) container is used to encapsulate the data of a streaming media to be transported, such that the data of the streaming media can be transported according to a TS encapsulation format. That is, the data is transported by using a TS. The TS may be filled with data of many types, such as video, audio, user-defined information, and the like. Specifically, the TS may be composed of a plurality of data packets of different types. The length of each data packet is 188 bytes. Each data packet includes two parts, namely a packet header and a load, respectively, wherein the packet header is of 4 bytes, and includes synchronization information, such as synchronization bytes 0x47, packet information, and the like; the load is of 184 bytes, and is data transported. The loads may constitute data streams, for example, packetized elementary streams (PES), namely PES packets. According to the data types of the loads, the PES packets may be divided into an audio data packet, a video data packet, and so on, which is not limited in the embodiments of the present disclosure.

In the transport process, the TS is transmitted in packets, i.e., transmitted on the basis of data packets. When the audio data packet is received, the audio data packet is detected to recognize a stream identifier from the packet header of the audio data packet, and then the stream type of the audio data packet can be determined on the basis of the stream identifier. As a stream identifier corresponding to audio data of Dolby DVB standard is the same as a stream identifier according to audio data of DTS-HD standard, a stream type corresponding to the same stream identifiers may be labeled as a first stream type.

As a specific example of this embodiment of the present disclosure, a stream type corresponding to the stream identifier 0x06 may be labeled as the first stream type in advance. Accordingly, a stream type corresponding to the stream identifier 0x81 may be labeled as a second stream type, and a stream type corresponding to the stream identifier 0x87 may be labeled as a third stream type. Among the three stream types, the first stream type includes a stream type corresponding to the Dolby DVB standard and a stream type corresponding to the DTS-HD standard. For example, upon detecting Stream Type=0x06, i.e., the recognized stream identifier is 0x06, it can be sure that the stream type of the audio data packet is the first stream type.

In a preferred embodiment of the present disclosure, the step of detecting the received audio data packet to determine the stream type of the audio data packet may include the substeps as follows.

Substep 10101, when a data packet is received, the data packet is processed to generate the audio data packet.

Substep 10103, header information of the audio data packet is detected to obtain a stream identifier.

Substep 10105, the stream type of the audio data packet is determined on the basis of the stream identifier.

Step 103, tag data of the audio data packet is obtained when the stream type is the first stream type.

The audio data packet includes the tag data, wherein the tag data is used for differentiating the format of the audio data. When the stream type of the audio data packet is the first stream type, the audio data is recognized continuously, so that the tag data of the audio data packet can be obtained. For example, upon detecting Stream Type=0x06, the audio data is recognized continuously, such that the tag data can be obtained from the audio data packet; if detecting that tag=0x06, the obtained tag data is 0x06, wherein 0x06 is equivalent to a tag identifier.

Typically, the tag identifier is saved in the packet header of the audio data packet. Hence, the tag identifier may be obtained b recognizing information (i.e., header information) included in the packet header. In a preferred embodiment of the present disclosure, the header information of the audio data packet includes the tag identifier. To obtain the tag data of the audio data packet, the tag identifier may be specifically obtained from the header information and then regarded as the tag data.

Step 105, a determination is made on whether the tag data belongs to preset Dolby tag information.

In fact, audio data generated by different audio techniques have different audio formats. On the basis of the audio format corresponding to Dolby technique, the Dolby tag information can be set in advance. The Dolby tag information may include different tag data. Therefore, different Dolby audio formats may be differentiated on the basis of the tag data. Further, it can be sure whether the audio data is Dolby audio data by determining whether the tag data belongs to the Dolby tag information.

In a preferred embodiment of the present disclosure the step of determining whether the tag data belongs to the preset Dolby tag information includes:

Substep 10501, a determination is made on whether the tag identifier is the one corresponding to the Dolby tag information.

Substep 10503, the tag data is determined to belong the Dolby tag inform ion when the one corresponding to the Dolby tag information.

Actually, the Dolby audio formats may include, but are not limited to, Dolby Surround Audio Coding-3 (AC3) format and Enhanced AC-3 bit streams (EAC3). Accordingly, the preset Dolby tag information may include, but is not limited to, 0x6a and 0x7a; that is, 0x6a and 0x7a are equivalent to the identifiers corresponding to the preset Dolby tag information, wherein the audio format corresponding to 0x6a is the Dolby AC3 format, while the audio format corresponding to 0x7a is the Dolby EAC3 format. For example, when the tag data is 0x6a or 0x7a, it can be determined that the tag data belongs to the Dolby tag information.

Step 107, the first stream type is determined as the stream type corresponding to the Dolby digital video broadcasting standard when the tag data belongs to the preset Dolby tag information, and the audio data packet is decoded by means of a Dolby decoder to generate the audio data.

When the tag data belongs to the Dolby tag information, it can be determined that the audio data is generated by the Dolby technique, and the, first steam type thus can be determined as the one corresponding to the Dolby DVB standard. That is, the audio data packet is the one corresponding to the Dolby DVB standard. The audio data then can be decoded by means of the Dolby decoder to generate the audio data. Specifically, for decoding the audio data by the Dolby decoder, the corresponding Dolby decoder can be determined according to the Dolby audio format of the audio data packet, and then the determined Dolby decoder is used to decode the audio data packet, such that the audio data of the Dolby DVB standard can be generated. As a result, analysis of the audio data of the Dolby DVB standard is completed, and then a terminal is able to read and play the audio data.

In a preferred embodiment of the present disclosure, the step of decoding the audio data packet by means of the Dolby decoder may include the substeps as follows.

Substep 10701, the tag data is recognized to determine the Dolby audio format corresponding to the tag data.

Substep 10703, the audio data packet is decoded by means of the Dolby decoder corresponding to the Dolby audio format to generate the audio data.

In this embodiment of the present disclosure, when the stream type of the audio data packet is the first stream type, the tag data of the audio data packet is obtained and the determination is made on whether the tag data belongs to the Dolby tag information. When the tag data belongs to the Dolby tag information, the first stream type is determined as the one corresponding to the Dolby DVB standard, thereby avoiding misrecognition of the audio data packet of the DVB standard as that of the DTS standard. Subsequently, the audio data packet is decoded by means of the Dolby decoder to generate the audio data. The processing on the audio data packet of the Dolby DVB standard then is completed, such that a terminal is able to play the audio data of the Dolby DVB standard.

In order to describe in detail the embodiment of the present disclosure, it will be described below in conjunction with preferred embodiments.

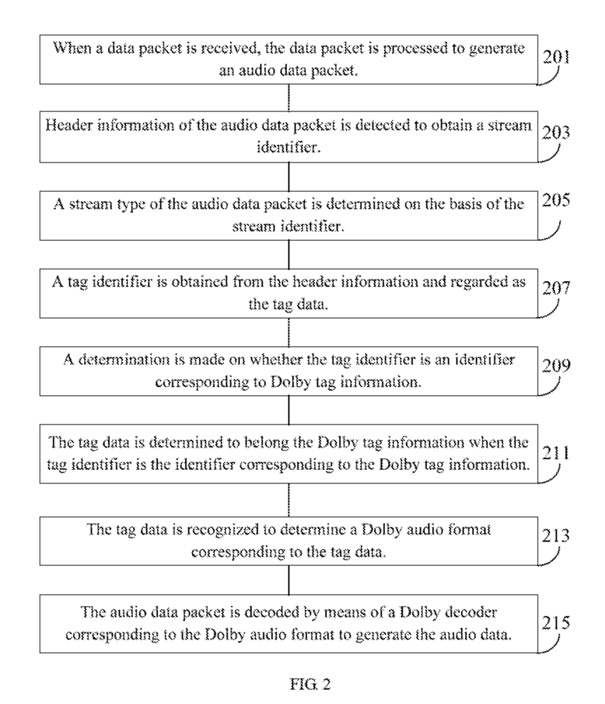

By referring to FIG. 2, illustrated is the step flow diagram of the preferred embodiment of the method for audio data processing of the present disclosure. The method may specifically include the following steps: Step 201, when a data packet is received, the data packet is processed to generate an audio data packet.

As a specific example of this embodiment of the present disclosure, when the data packet is received, it is first typically to check whether the data packet contains synchronization bytes 0x47. If the synchronization bytes 0x47 exist, the received data packet is parsed by means of a parser to generate PES packets. Therefore, such data as audio, video, caption, and the like can be separated out, thereby completing parsing of a TS and generating an audio data packet, a video data packet, and so on, which is not limited in this embodiment of the present disclosure.

Step 203, header information of the audio data packet is detected to obtain a stream identifier.

Actually, packet information of a data packet is typically saved in a packet header of the data packet. Detecting the packet header of the audio data packet is equal to detecting the header information of the audio data packet, and therefore, the stream identifier of the audio data packet can be obtained upon recognition of the stream identifier. The stream identifier may include, but is not limited to, 0x81, 0x87, 0x06, and so on. Different stream identifiers can be preset by a person skilled in the art on the basis of the standards of the audio data, which is not limited in this embodiment of the present disclosure.

Step 205, a stream type of the audio data packet is determined on the basis of the stream identifier.

In this embodiment of the present disclosure, different stream identifiers correspond to different stream types. The stream type of the audio data packet thus can be determined on the basis of the stream identifier. For example, the stream type corresponding to the stream identifier 0x06 is labeled as a first stream type; the stream type corresponding to the stream identifier 0x81 is labeled as a second stream type. When the obtained stream identifier is 0x06, i.e., Stream Type=0x06, it can be determined that the stream type of the audio data packet is the first stream type. When the stream type is the first stream type, step 207 is carried out.

Of course, when the obtained stream identifier is 0x81 or 0x87, the audio data can be parsed according to the present processing method, which is not limited in this embodiment of the present disclosure.

Step 207, a tag identifier is obtained from the header information and regarded as the tag data.

Actually, by detecting the header information of the audio data packet, the tag identifier of the audio data packet may also be recognized; in other words, the tag identifier can be obtained from the header information, and the obtained tag identifier is regarded as the tag data of the audio data packet.

Step 209, a determination is made on whether the tag identifier is an identifier corresponding to Dolby tag information.

The tag identifier may be used to differentiate the format of the audio data. For example, the tag identifier 0x6a may represent Dolby AC3 format; the tag identifier 0x7a may represent Dolby EAC3 format. The identifier corresponding to the Dolby tag information may include 0x6a 0x7a, and so on, which is not limited in this embodiment of the present disclosure. In this way, it can be found out whether the tag data belongs to the Dolby tag information by determining whether the tag identifier is the identifier corresponding to the Dolby tag information.

Step 211, the tag data is determined to belong the Dolby tag information when the tag identifier is the identifier corresponding to the Dolby tag information.

Specifically, when the tag identifier is the identifier corresponding to the Dolby tag information, it may be decided that the tag data belongs to the Dolby tag information. When the tag data belongs to the Dolby tag information, it can be determined that the first stream type is the one corresponding to the Dolby digital video broadcasting standard, i.e., the audio data packet is the one of the Dolby DVB standard. Therefore, misrecognition of the audio data packet of the DVB standard as that of the DTS standard can be avoided. Next, step 213 is carried out.

Step 213, the tag data is recognized to determine a Dolby audio format corresponding to the tag data.

Specifically, the audio data is typically generated from a Dolby sound source according to the Dolby AC3 format or the Dolby EAC3 format, wherein the tag data corresponding to the Dolby AC3 format is 0x6a, the tag data corresponding to the Dolby EAC3 format is 0x7a. When the tag data is 0x6a, i.e., tag=0x6a, it can be determined that the audio format of the audio data packet is the Dolby AC3 format; upon tag=0x7a, it can be determined that the audio format of the audio data packet is the Dolby EAC3 format.

Step 215, the audio data packet is decoded by means of a Dolby decoder corresponding to the Dolby audio format to generate the audio data.

In a preferred embodiment of the present disclosure, the Dolby audio formats include a Dolby surround audio coding-3 format and an enhanced audio coding-3 bit streams format, wherein a Dolby decoder corresponding to the Dolby surround audio coding-3 format is a first decoder, while a Dolby decoder corresponding to the enhanced audio coding-3 bit streams format is a second decoder. Optionally, the step of decoding the audio data packet by means of the Dolby decoder corresponding to the Dolby audio format to generate the audio data include the substeps as follows.

Substep 21501, a determination is made on whether the Dolby audio format is the Dolby surround audio coding-3 format.

Substep 21503, the audio data packet is decoded by using the first decoder to generate the audio data when the Dolby audio format is the Dolby surround audio coding-3 format.

Actually, it can be found out whether the audio data packet is in the Dolby AC3 format by determining whether the tag identifier is 0x6a. When the audio format of the audio data packet is the Dolby AC3 format, the first decoder is used to decode the audio data packet, thereby generating the audio data corresponding to the Dolby AC3 format. Therefore, misrecognition of the audio data packet of the Dolby AC3 format as that of other Dolby audio formats (e.g., the Dolby EAC3 format) can be avoided.

Optionally, the step of decoding the audio data packet by means of the Dolby decoder corresponding to the Dolby audio format to generate the audio data may also include the substeps as follows.

Substep 21511, a determination is made on whether the Dolby audio format is the enhanced audio coding-3 bit streams format.

Substep 21513, the audio data packet is decoded by using the second decoder to generate the audio data when the Dolby audio format is the enhanced audio coding-3 bit streams format.

In this embodiment of the present disclosure, it can be found out whether the audio data, packet is in the Dolby EAC3 format by determining whether the tag identifier is 0x7a. When the audio format of the audio data packet is the Dolby EAC3 format, the second decoder is used to decode the audio data packet, thereby generating the audio data corresponding to the Dolby EAC3 format. Therefore, misrecognition of the audio data packet of the Dolby EAC3 format as that of other Dolby audio for is (e.g., the Dolby AC3 format) can be avoided.

In specific implementation, a determination may be made first on whether the Dolby audio format is the Dolby AC3 format, and then a determination is made on whether the Dolby audio format is the Dolby EAC3 format when the Dolby audio format is not the Dolby AC3 format. That is, substep 21501 may be carried out first, and then substep 21511 is carried out when the Dolby audio format is riot the Dolby AC3 format. Otherwise, substep 21511 may be carried out first, and then substep 21501 is carried out when the Dolby audio format is not the Dolby EAC3 format. This is not limited in the present disclosure.

By means of this embodiment of the present disclosure, the header information of the audio data packet may be detected to obtain the stream identifier, such that the stream type of the audio data packet can be determined. When the stream type is the first stream type, the tag identifier is obtained from the header information, and the determination is made on whether the tag identifier is the one corresponding to the Dolby tag information, thereby avoiding misrecognition of the audio data packet of the Dolby DVB standard as that of the DTS standard. As a result, it can be avoided that a failure in parsing the audio data of the Dolby DVB standard leads to that the audio data cannot be played.

In addition, according to this embodiment of the present disclosure, the Dolby audio format of the audio data packet may also be determined according to the tag identifier, and the audio data packet is decoded by using the decoder corresponding to the Dolby audio format. The audio data packet thus may be decoded correctly. The efficiency of decoding is improved while the accuracy of decoding is guaranteed.

It needs to be noted that, concerning the method embodiments, for the sake of simple descriptions, they are all expressed as combinations of a series of actions. However, a person skilled in the art should know that the embodiments of the present disclosure are not limited by the described order of actions, because some steps may be carried out in other orders or simultaneously according to the embodiments of the present disclosure. For another, a person skilled in the art should also know that the embodiments described in the description all are preferred embodiments, and the actions involved therein are not necessary for the embodiments of the present disclosure.

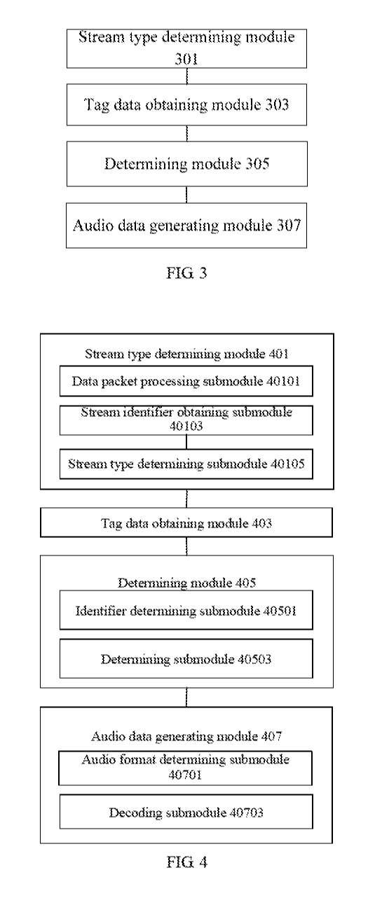

By referring to FIG. 3, illustrated is the structure block diagram of the embodiment of the device for audio data processing of the present disclosure. The device may specifically include the following modules:

a stream type determining module 301 configured to detect a received audio data packet to determine a stream type of the audio data packet;

a tag data obtaining module 303 configured to obtain tag data of the audio data packet when the stream type is a first stream type;

determining module 305 configured to determine whether the tag data belongs to preset Dolby tag information;

an audio data generating module 307 configured to determine the first stream type as a stream type corresponding to a Dolby digital video broadcasting standard when the tag data belongs to the preset Dolby tag information, and decode the audio data packet by means of a Dolby decoder to generate audio data.

In this embodiment of the present disclosure, when the stream type of the audio data packet is the first stream type, the tag data of the audio packet is obtained and the determination is made on whether the tag data belongs to Dolby tag information. When the tag data belongs to the Dolby tag information, the first stream type is determined as the one corresponding to the Dolby DVB standard, thereby avoiding misrecognition of the audio data packet of the DVB standard as that of the DTS standard. The audio data packet is then decoded by means of the Dolby decoder to generate the audio data. Therefore, the processing on the audio data packet of the Dolby DVB standard is completed, such that a terminal is able to play the audio data of the Dolby DVB standard.

By referring to FIG. 4, illustrated is the structure block diagram of the preferred embodiment of the device for audio data processing of the present disclosure, the device may specifically include the following modules.

A stream type determining module 401 is configured to detect a received audio data packet to determine a stream type of the audio, data packet.

Optionally, the stream type determining module 401 may include the following, submodules: a data packet processing submodule 40101, a stream identifier obtaining submodule 40103, and a stream type determining submodule 40105.

Among these submodules, the data packet processing submodule 40101 is configured to, when a data packet is received, process the data packet to generate the audio data packet. The stream identifier obtaining submodule 40103 is configured to detect header information of the audio data packet to obtain a stream identifier. The stream type determining submodule 40105 is configured to determine the stream type of the audio data packet on the basis of the stream identifier. When the stream type is a first stream type, a tag data obtaining module 403 may be triggered.

In a preferred embodiment of the present disclosure, the header information of the audio data packet includes a tag identifier. The tag data obtaining module 403 may be specifically configured to obtain the tag identifier from the header information to serve as the tag data.

A determining module 405 is configured to determine whether the tag data belongs to preset Dolby tag information.

In a preferred embodiment of the present disclosure, the determining module 405 may include an identifier determining submodule 40501 and a determining submodule 40503.

Between the submodules, the identifier determining submodule 40501 is configured to determine whether the tag identifier is an identifier corresponding to the Dolby tag information. The determining submodule 40501 is configured to determine that the tag data belongs to the Dolby tag information when the tag identifier is the identifier corresponding to the Dolby tag information.

An audio data generating module 407 is configured to determine the first stream type as a stream type corresponding to a Dolby digital video broadcasting standard when the tag data belongs to the preset Dolby tag information, and decode the audio data packet by means of a Dolby decoder to generate audio data.

In a preferred embodiment of the present disclosure, the audio data generating module 407 may include an audio format determining submodule 40701 and a decoding submodule 40703.

Between the submodules, the audio format determining submodule 40701 is configured to recognize the tag data to determine a Dolby audio format corresponding to the tag data. The decoding submodule 40703 is configured to decode the audio data packet by means of a Dolby decoder corresponding to the Dolby audio format to generate the audio data.

In a preferred embodiment of the present disclosure, the Dolby audio formats include a Dolby surround audio coding-3 format or an enhanced audio coding-3 bit streams format, wherein a Dolby decoder corresponding to the Dolby surround audio coding-3 format is a first decoder, while a decoder corresponding to the enhanced audio coding-3 bit streams format is a second decoder.

Optionally, the decoding submodule 40703 may include the following units:

a first determining unit configured to determine whether the Dolby audio format is the Dolby surround audio coding-3 format;

a first decoding unit configured to decode the audio data packet rising the first decoder to generate the audio data when the Dolby audio format is the Dolby surround audio coding-3 format;

a second determining unit configured to determine whether the Dolby audio format is the enhanced audio coding-3 bit streams format;

a second decoding unit configured to decode the audio data packet using the second decoder to generate the audio data when the Dolby audio format is the enhanced audio coding-3 bit streams format.

By means of the this embodiment of the present disclosure, the header information of the audio data packet may be detected to obtain the stream identifier, such that the stream type of the audio data packet can be determined. When the stream type is the first stream type, the tag identifier is obtained from the header information, and the determination is made on whether the tag identifier is the one corresponding to the Dolby tag information, thereby avoiding misrecognition of the audio data packet of the Dolby DVB standard as that of the DTS standard. As a result, it can be avoided that a failure in parsing the audio data of the Dolby DVB standard leads to that the audio data cannot be played.

In addition, according to this embodiment of the present disclosure, the Dolby audio format of the audio data packet may also be determined according to the tag identifier, and the audio data packet is decoded by using the decoder corresponding to the Dolby audio format. The audio data packet thus may be decoded correctly. The efficiency of decoding is improved while the accuracy of decoding is guaranteed.

Concerning the device embodiments, they are just simply described as being substantially similar to the method embodiments, the correlations therebetween just refer to part of descriptions of the method embodiments.

Each embodiment in the description is described in a progressive manner. Descriptions emphasize on the differences of each embodiment from other embodiments, and same or similar parts of various embodiments just refer to each other.

A person skilled in the art should understand that the embodiments of the present disclosure may be provided as methods, devices, or computer program products. Hence, the embodiments of the present disclosure may be in the form of complete hardware embodiments, complete software embodiments, or a combination of embodiments in software and hardware aspects. Moreover, the embodiments of the present disclosure may be in the form of computer program products executed on one or more computer-readable storage mediums containing therein computer-executable program codes (including but not limited to a magnetic disk memory, a CD-ROM, an optical memory, etc.).

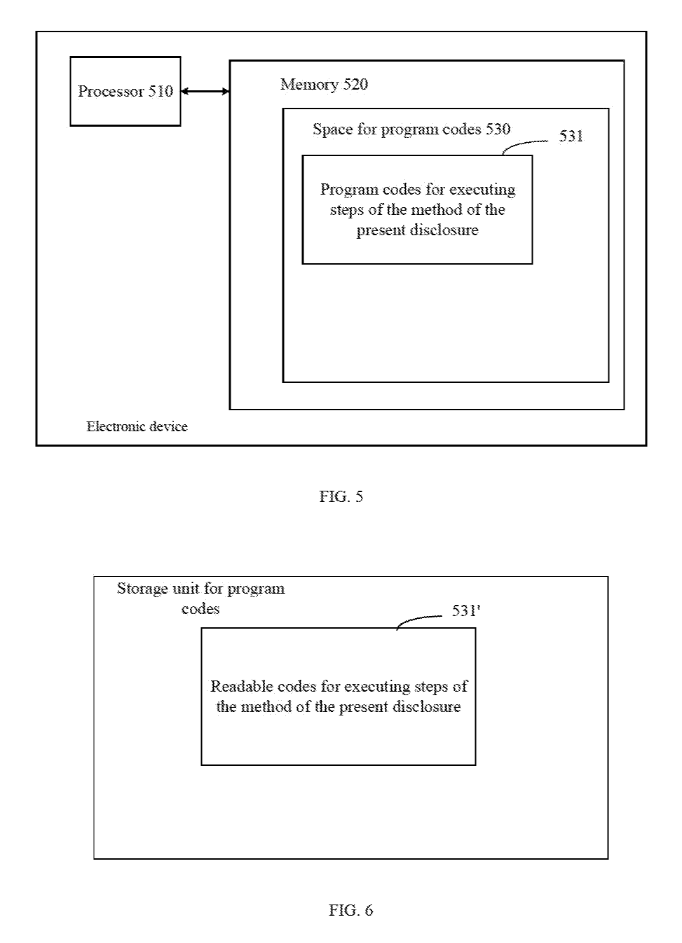

For example, FIG. 5 illustrates a block diagram of an electronic device for executing the method according the disclosure. The electronic device may be the terminal above. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the electronic device as shown in FIG. 5. The program codes may be compressed for example in an appropriate form. Usually, the memory cell includes computer readable codes 531′ which can be read for example by processors 510. When these codes are operated on the electronic device, the electronic device may execute respective steps in the method as described above.

The embodiments of the present disclosure are described with reference to the flow diagrams and/or the block diagrams of the method, a terminal device (system), and the computer program product(s) according to the embodiments of the present disclosure. It should be appreciated that computer program commands may be adopted to implement each flow and/or block in each flow diagram and/or each block diagram, and a combination of the flows and/or the blocks in each flow diagram and/or each block diagram. These computer program commands may be provided to a universal computer, a special purpose computer, an embedded processor or a processor of another programmable data processing terminal equipment to generate a machine, such that the commands executed by the computer or the processor of another programmable data processing terminal equipment create a device for implementing functions specified in one flow or multiple flows of each flow diagram and/or one block or multiple blocks of each block diagram.

These computer program commands may also be stored in a computer-readable memory that is capable of guiding the computer or another programmable data processing terminal equipment to work in a specified mode, such that the commands stored in the computer-readable memory create a manufacture including a command device for implementing functions specified in one flow or multiple flows of each flow diagram and of one block or multiple blocks of each block diagram.

Further, these computer program commands may be loaded on the computer or another programmable data processing terminal equipment, such that a series of operation steps are executed on the computer or another programmable data processing terminal equipment to generate processing, implemented by the computer; in this way, the commands executed on the computer or another programmable data processing terminal equipment provide steps for implementing functions specified in one flow or multiple flows of each flow diagram and/or one block or multiple blocks of each block diagram.

While the preferred embodiments amongst the embodiments of the present disclosure are already described, those skilled in the art may make other alterations and modifications to these embodiments once they learn about the basic creative concept. Hence, the appended claims are meant to be interpreted as including the preferred embodiments and all the alterations and modifications falling into the scope of the embodiments of the present disclosure.

Finally, it still needs to be noted that relational terms such as first, second, and the like in this text are merely used for differentiating one entity or operation from another entity or operation rather than definitely requiring or implying any actual relationship or order between these entities or operations. In addition, the terms “including” and “comprising”, or any other variants thereof are intended to contain non-exclusive including, such that a process, a method, an article or a terminal device including a series of elements includes not only those elements, but also other elements not explicitly listed, or further includes inherent elements of the process, the method, the article or the terminal device. Without more limitations, elements defined by the sentence of “including a . . . ” shall not be exclusive of additional same elements also existing in the process, the method, the article or the terminal device.

The method for audio data processing and the device for audio data processing provided by the present disclosure are introduced above in detail. Specific examples are applied in this text to elaborate the principle and the embodiments of the present disclosure. The above descriptions of the embodiments are merely intended to help understanding the method of the present disclosure and the core concept thereof. Meanwhile, for a person skilled in the art, alterations may be made to the specific embodiments and the application scope according to the concept of the present disclosure. In conclusion, the contents of this description should not be understood as limitations to the present disclosure.

What is claimed is:

1. A method for audio data processing, comprising:
at an electronic device:
detecting a received audio data packet to determine a stream type of the audio data packet;
obtaining tag data of the audio data packet when the stream type is a first stream type;
determining whether the tag data belongs to preset Dolby tag information;
determining the first stream type as a stream type corresponding to a Dolby digital video broadcasting standard when the tag data belongs to the preset Dolby tag information, and decoding the audio data packet by means of a Dolby decoder to generate audio data.

2. The method according to claim 1, wherein detecting the received audio data packet to determine the stream type of the audio data packet comprises:
when a data packet is received, processing the data packet to generate the audio data packet:
detecting header information of the audio data packet to obtain a stream identifier;
determining the stream type of the audio data packet on the basis of the stream identifier.

3. The method according to claim 2, wherein the header information comprises a tag identifier; the step of obtaining the tag data of the audio data packet comprises:
obtaining the tag identifier from the header information and regarding the tag identifier as the tag data.

4. The method according to claim 3, wherein determining whether the tag data belongs to the preset Dolby tag information comprises:
determining whether the tag identifier is an identifier corresponding to the Dolby tag information;
determining that the tag data belongs to the Dolby tag information when the tag identifier is the identifier corresponding to the Dolby tag information.

5. The method according to claim 1, wherein the step of decoding the audio data packet by means of the Dolby decoder comprises:
recognizing the tag data to determine a Dolby audio format corresponding to the tag data;
decoding the audio data packet by means of a Dolby decoder corresponding to the Dolby audio format to generate the audio data.

6. The method according to claim 5, wherein the Dolby audio format is a Dolby surround audio coding-3 format or an enhanced audio coding-3 bit streams format, wherein a Dolby decoder corresponding to the Dolby surround audio coding-3 format is a first decoder, while a decoder corresponding to the enhanced audio coding-3 bit streams format is a second decoder.

7. The method according to claim 6, wherein decoding the audio data packet by means of the Dolby decoder corresponding to the Dolby audio format to generate the audio data comprises:
determining whether the Dolby audio format is the Dolby surround audio coding-3 format;
decoding the audio data packet using the first decoder to generate the audio data when the Dolby audio format is the Dolby surround audio coding-3 format.

8. The method according to claim 7, wherein the decoding the audio data packet by means of the Dolby decoder corresponding to the Dolby audio format to generate the audio data comprises:
determining whether the Dolby audio format is the enhanced audio coding-3 bit streams format;
decoding the audio data packet using the second decoder to generate the audio data when the Dolby audio format is the enhanced audio coding-3 bit streams format.

9. An electronic device, comprising:
at least one processor; and
a memory communicably connected with the at least one processor for storing instructions executable by the at least one processor, wherein execution of the instructions by the at least one processor causes the at least one processor to:
detect a received audio data packet to determine a stream type of the audio data packet;
obtain tag data of the audio data packet when the stream type is a first stream type;
determine whether the tag data belongs to preset Dolby tag information;
determine the first stream type as a stream type corresponding to a Dolby digital video broadcasting standard when the tag data belongs to the preset Dolby tag information, and decode the audio data packet by means of a Dolby decoder to generate audio data.

10. The electronic device according to claim 9, wherein detect a received audio data packet to determine a stream type of the audio data packet comprises:
when a data packet is received, process the data packet to generate the audio data packet;
detect header information of the audio data packet to obtain a stream identifier;
determine the stream type of the audio data packet on the basis of the stream identifier.

11. The electronic device according to claim 10, wherein the header information comprises a tag identifier; obtain tag data of the audio data packet when the stream type is a first stream type comprises: obtain the tag identifier from the header information to serve as the tag data.

12. The electronic device according to claim 11, wherein determine whether the tag data belongs to preset Dolby tag information comprises:
determine whether the tag identifier is an identifier corresponding to the Dolby tag information;
determine that the tag data belongs to the Dolby tag information when the tag identifier is the identifier corresponding to the Dolby tag information.

13. The electronic device according to claim 9, wherein determine the, first stream type as a stream type corresponding to a Dolby digital video broadcasting standard when the tag data belongs to the preset Dolby tag information, and decode the audio data packet by means of a Dolby decoder to generate audio data comprises:
recognize the tag data to determine a Dolby audio format corresponding to the tag data;
decode the audio data packet by means of a Dolby decoder corresponding to the Dolby audio format to generate the audio data.

14. The electronic device according to claim 13, wherein the Dolby audio format is a Dolby surround audio coding-3 format or an enhanced audio coding-3 bit streams format, wherein a Dolby decoder corresponding to the Dolby surround audio coding-3 format is a first decoder, while a decoder corresponding to the enhanced audio coding-3 bit streams format is a second decoder

15. The electronic device according to claim 14, wherein decode the audio data packet by means of a Dolby decoder corresponding to the Dolby audio format to generate the audio data comprises:
determine whether the Dolby audio format is the Dolby surround audio coding-3 format;
decode the audio data packet using the first decoder to generate the audio data when the Dolby audio format is the Dolby surround audio coding-3 format.

16. The electronic device according to claim 13, wherein decode the audio data packet by means of a Dolby decoder corresponding to the Dolby audio format to generate the audio data further comprises:
determine whether the Dolby audio format is the enhanced audio coding-3 bit streams format;
decode the audio data packet using the second decoder to generate the audio data when the Dolby audio format is the enhanced audio coding-3 bit streams format.

17. A non-transitory computer-readable medium storing executable instructions that, when executed by an electronic device, cause the electronic device to:
detect a received audio data packet to determine a stream type of the audio data packet;
obtain tag data of the audio data packet when the stream type is a first stream type;
determine whether the tag data belongs to preset Dolby tag information;
determine the first stream type as a stream type corresponding to a Dolby digital video broadcasting standard when the tag data belongs to the preset Dolby tag information, and decode the audio data packet by means of a Dolby decoder to generate audio data.
